(19) United States
(12) Patent Application Publication
(10) Pub. No.: US 2008/0048468 A1
(43) Pub. Date: Feb. 28, 2008

(54) Air drag reduction apparatus for tractor-trailers

(76) Inventor: Robert Holubar, Omaha, NE (US)

Correspondence Address: LAW OFFICES OF ADAM H. JACOBS;SUITE 726, 1904 FARNAM STREET, OMAHA, NE, 68102, US

(21) Appl. No.: 11/827,721

(22) Filed: Jul. 13, 2007

Related U.S. Application Data
(63) Continuation-in-part of application No. 11/508,795, filed on Aug. 23, 2006, now abandoned.

(51) Int. Cl. B60J 1/18

(52) U.S. Cl. 296/180.4

(57) ABSTRACT

A air drag reduction apparatus includes left and right planar panels and top and bottom planar panels for mounting to the rear doors of a tractor trailer along the top, bottom and side edges thereof. Hinges are interposed between the panels and the doors so that the panels can pivot about the hinges between an extended drag-reducing position and a collapsed position generally adjacent the rear doors. Stop devices releasably secure the panels in the extended position, and biasing devices such as tensioning springs are operative to bias the panels outwards and rearwards to the extended position and are further operative to permit the panels to pivot between the extended position towards and to the collapsed position upon impact and contact from an external object occurring and then return to the extended position substantially immediately upon contact ceasing thereby significantly reducing the impact damage.

### CROSS-REFERENCE TO RELATED APPLICATION

This continuation-in-part application claims priority to the filing date of related patent application Ser. No. 11/508,795 filed on Aug. 23, 2006.

### BACKGROUND OF THE INVENTION

1. Technical Field

The present invention is directed to air drag reduction devices for vehicles and, more particularly, to an air drag reduction apparatus for tractor-trailers which includes left, right, top and bottom planar panels which are hingedly mounted on the generally rectangular rear doors of the tractor-trailer and which extend at an angle of approximately five to twenty-five degrees inwards from parallel alignment with the top, bottom and side walls of the tractor-trailer when the panels are in their extended drag-reducing position, the device further including a set of biasing devices such as springs mounted within or adjacent the hinges which are operative to permit the left, right, top and bottom planar panels to pivot between the extended position and a collapsed position adjacent and contacting the rear doors such that upon the panels receiving impact from an external object, damage to the panels is significantly reduced due to their being collapsibly mounted on the rear doors.

2. Description of the Prior Art

Operation of tractor-trailer units involves significant expenditures for maintenance and upkeep, but the single most costly element of operation is almost certainly the fuel costs required to operate the tractor-trailer. One of the operational features which most significantly increases the fuel consumption cost is the fact that the tractor-trailer as commonly used presents an extremely inefficient aerodynamic shape, as the size and shape of the tractor-trailer is generally dictated by the amount of cargo and size and shape thereof which the tractor-trailer needs to carry. Therefore, a large rectangular box shape is generally used for the trailer unit, as this shape is most conducive to loading and unloading and carrying of cargo therein. However, it is also well-known that the rectangular box shape presents one of the most aerodynamically inefficient shapes known, and it is not only the forward flat front of the trailer which presents aerodynamic inefficiencies, but the rear of the trailer likewise is aerodynamically inefficient, due to the large amounts of turbulence and drag produced by air flow over the top, bottom and sides of the trailer to the squared-off rear. Particularly due to ever-increasing fuel prices, improvement of the aerodynamics of the tractor-trailer is becoming ever more important, and therefore there is a need to improve the aerodynamic performance of the tractor-trailer unit.

Many different inventions have been proposed in the prior art which attempt to address and solve this problem. For example, Roberge et al., U.S. Pat. No. 6,485,087, discloses a rear panel configuration for attachment to the rear of a tractor-trailer which is designed to significantly reduce the turbulence and drag produced by the rear of the unadorned trailer. However, while Roberge does provide one form of solution to the aerodynamic problem, it raises other problems, namely, what happens when, inevitably, the panels encounter an external object such as a loading dock or other vehicle? As taught in the Roberge patent, specifically in FIG. 9 of Roberge, a rubber flexible material would be applied to the leading edge of the panel to lessen the damage caused by the impact. Of course, such a rubber flexible edge will be of little use when the panel encounters a loading dock or the like, and it is clear that in such an instance the impact will cause a great deal of damage to the aerodynamic panel.

Many other devices are proposed in the prior art which also incorporate aerodynamic panels on the rear of the tractor-trailer, but not a single one of these addresses the issue of what occurs when the panel impacts a loading dock or the like, as will inevitably occur when the tractor-trailer is being backed into the loading and unloading location. While some of the devices apparently teach manually moving the panels to a storage position prior to opening the rear doors and loading and/or unloading the trailer, this does not fully address the question of what occurs when the driver or loading dock personnel simply forget to move the panels to their storage position. Therefore, there is a significant need for an aerodynamic panel device which will not only function to significantly reduce the cost of operating the tractor-trailer, but also addresses and solves the question of what occurs when the panels accidentally impact an external object such as a loading dock or the like.

Therefore, an object of the present invention is to provide an improved air drag reduction apparatus for tractor-trailers which will significantly reduce and/or eliminate damage to the aerodynamic panels caused by non-ballistic impact with external objects.

Another object of the present invention is to provide an improved air drag reduction apparatus for tractor-trailers which includes left, right, top and bottom planar panels which are hingedly mounted directly on the rear doors of the trailer, the panels extending rearwards in an extended drag-reducing position at an angle of approximately five to twenty-five degrees inwards relative to the planes defined by the top, bottom and sides of the tractor-trailer.

Another object of the present invention is to provide an improved air drag reduction apparatus for use with tractor-trailers which includes stop devices such as cables or hinge stops which releasably secure the panels in an extended position to generally ensure that the proper angle of orientation is maintained during operation of the tractor-trailer.

Another object of the present invention is to provide an improved air drag reduction apparatus for use with tractor-trailers which includes biasing devices operatively associated with the planar panels which are operative to bias the planar panels outwards and rearwards to the extended position and which are further operative to permit each of the planar panels to pivot between the extended position towards and to the collapsed position upon the panels receiving impact and contact from an external object and then return to the extended position substantially immediately upon contact with the external object ceasing such that damage to the left, right, top and bottom planar panels from the impact is significantly reduced or eliminated.

Finally, an object of the present invention is to provide an improved air drag reduction apparatus for use with tractor-trailers which is relatively simple and durable in design and construction and is safe, efficient and effective in use.

### SUMMARY OF THE INVENTION

The present invention provides an air drag reduction apparatus for use with vehicles having generally rectilinear top, side and base walls and a generally rectangular rear door, the apparatus including left, right, top and bottom generally trapezoidal planar panels each having an inner edge and an outer edge and a plurality of hinges mounted on the inner edges of each of the panels, the hinges adapted to be mounted on the rear door of the vehicle such that the left, right, top and bottom planar panels are pivotably mounted thereon. The hinge devices are further operative to permit each of the planar panels to pivot between an extended drag-reducing position which extends generally rearwardly at approximately five to twenty-five degrees of angle relative to the planes formed by the top, side and base walls of the tractor-trailer and a collapsed position generally adjacent the rear door. Stop devices such as cables and/or hinge stops are operatively associated with each of the planar panels for releasably securing the panels in the extended drag-reducing position. Finally, a plurality of biasing devices such as springs and/or gas-driven pistons are operatively associated with the left, right, top and bottom planar panels to bias the panels outwards and rearwards to the extended position and are further operative to permit each of the panels to pivot between the extended position towards and to the collapsed position upon the particular panel receiving impact and contact from an external object. The biasing devices are then further operative to return the panel to the extended position substantially immediately upon contact with the external object ceasing such that damage to the left, right, top and bottom planar panels from the impact is significantly reduced or eliminated.

The present invention as thus described provides a significant advantage over other aerodynamic enhancing prior art devices. Specifically, the most significant problem encountered with aerodynamic panels mounted on tractor-trailer units is that the panels are prone to receive accidental non-ballistic impacts which damage the panels, due to the outwardly extending configuration of the panels, thus reducing their effectiveness and eventually requiring replacement of the panels. This significantly increases the cost of operation in using the aerodynamic panels found in the prior art, which immediately and significantly brings into question the value of incorporating such aerodynamic panels, as the savings provided by incorporation of the panels is likely to be substantially offset by the cost of replacement and repair of the panels. None of the devices found in the prior art address or solve this problem, as many of the prior art devices require active retraction or movement of the panels to prevent impact damage. Of course, it is the unintentional damage which presents the significant problem in connection with the known prior art, and it is the significant improvement of the present invention to provide a solution to this problem. It is therefore seen that the present invention provides a substantial improvement over those devices found in the prior art.

### BRIEF DESCRIPTION OF THE DRAWINGS

FIG. 1 is a perspective view of the air drag reduction apparatus of the present invention;

FIG. 2 is a perspective view of the invention during impact;

FIG. 3 is a top plan view showing how the panels are pivoted on the trailer;

FIG. 4 is a rear elevational view of the present invention mounted on a trailer;

FIG. 5 is a side elevational view of a side panel of the present invention;

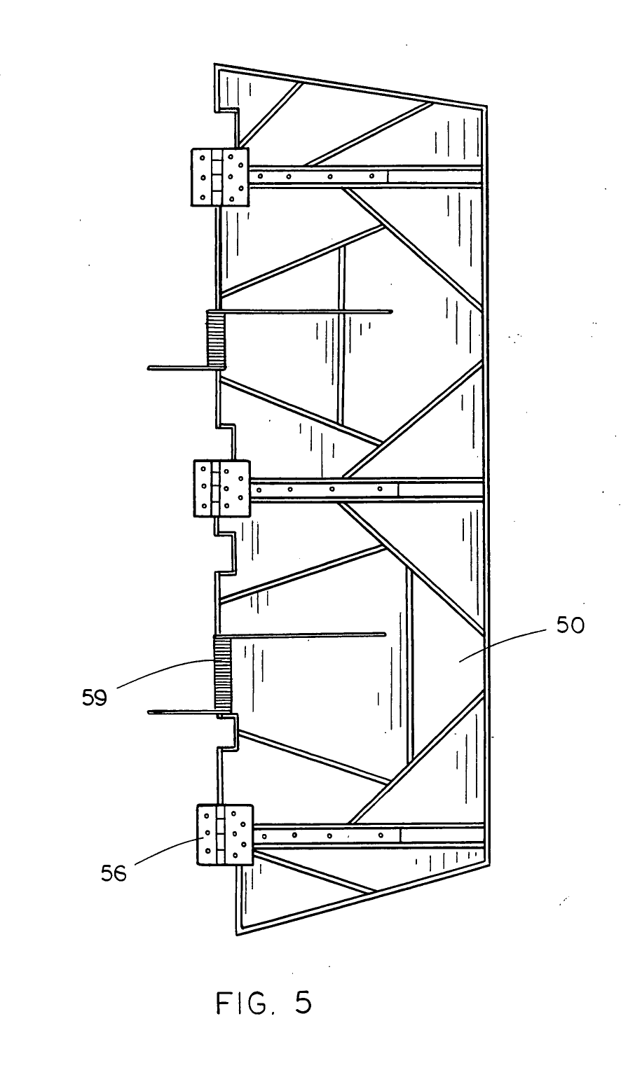

FIG. 6 is a top plan view showing the top panel of the invention;

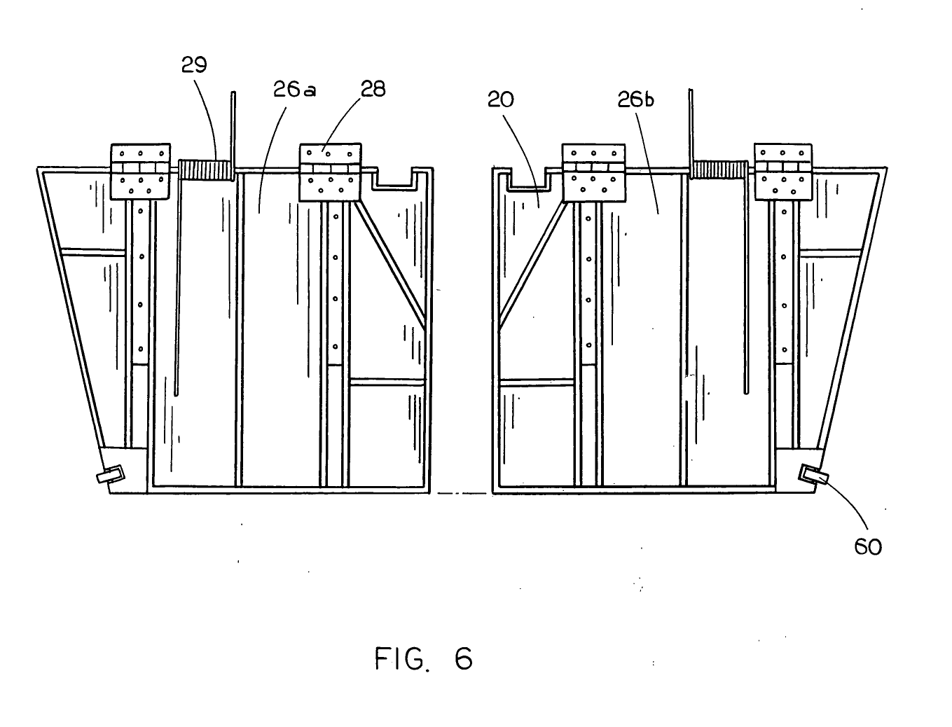

FIG. 7 is a perspective view of an alternative embodiment of the air drag reduction apparatus of the present invention;

FIG. 8 is a rear elevational view of the embodiment of FIG. 7 mounted on a trailer;

FIG. 9 is a detailed perspective view of the embodiment of FIG. 7 folding down to the collapsed position;

FIG. 10 is a detailed perspective view of the embodiment of FIG. 7 showing the roller wheels which cooperate to allow the panels to fold down; and

FIG. 11 is a top plan view of the embodiment of FIG. 7 showing the curvature of the panels and the extended and collapsed positions thereof.

### DESCRIPTION OF THE PREFERRED EMBODIMENT

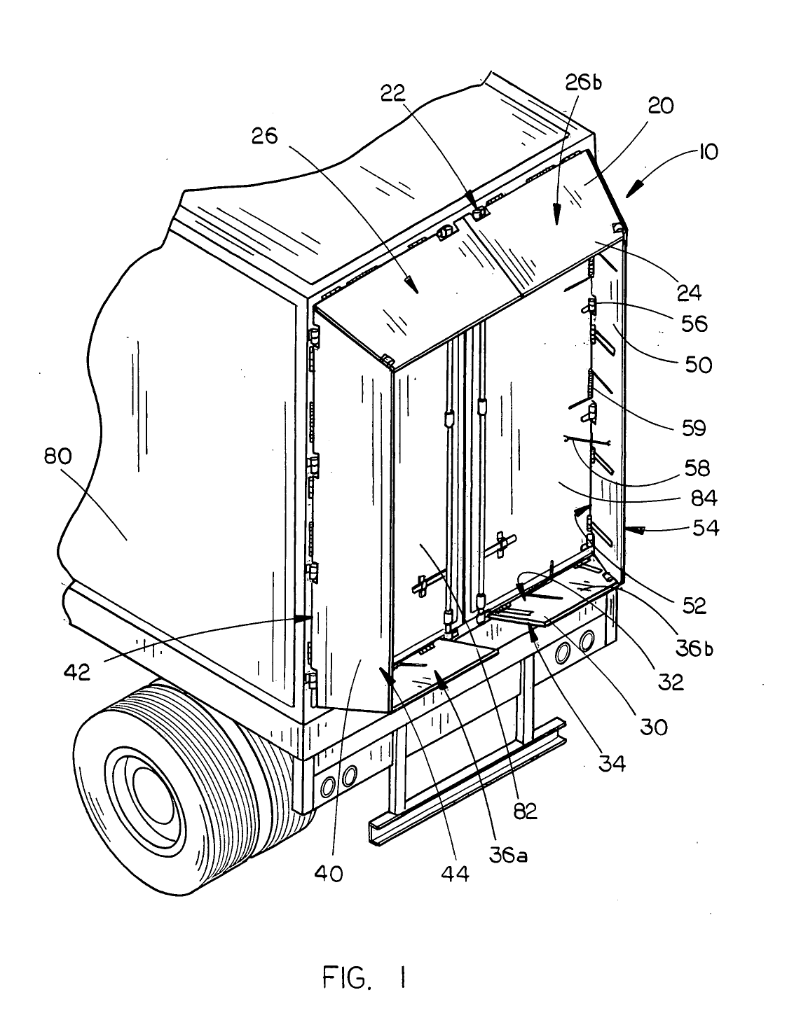

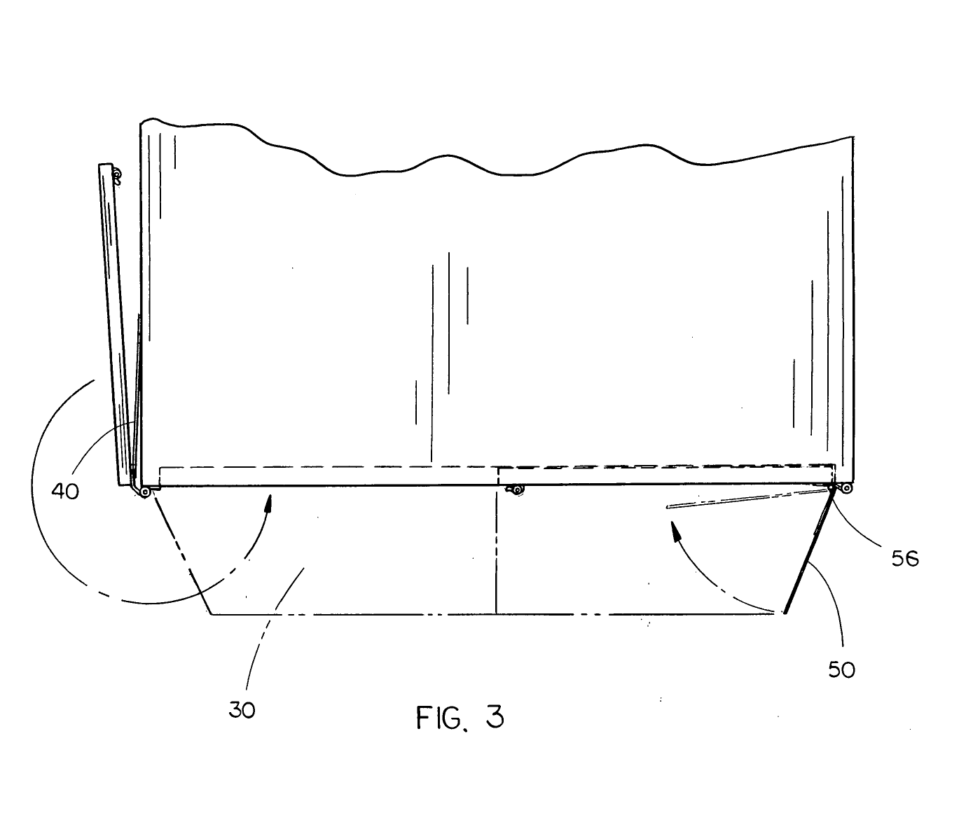

The air drag reduction apparatus 10 of the present invention is shown best in FIGS. 1-4 as including four aerodynamic panels, specifically a top panel 20, bottom panel 30, left side panel 40, and right side panel 50. It is preferred that each of the panels have the same general shape, namely, a trapezoidal shape, with the inner edges 22, 32, 42, and 52 of each of the panels having a greater length than the outer edges 24, 34, 44, and 54 of each of the panels. In the preferred embodiment, each of the panels, 20, 30, 40, and 50 would be constructed of a sturdy plastic or metal sheet material, although it has been found that the use of plastic material will significantly decrease the weight of the panels 20, 30, 40, and 50 while simultaneously not sacrificing durability and effectiveness. Of course, however, the precise nature of the construction materials used in connection with the panels 20, 30, 40, and 50 is not critical to the present invention so long as the aerodynamic enhancing features of the present invention are neither degraded nor destroyed.

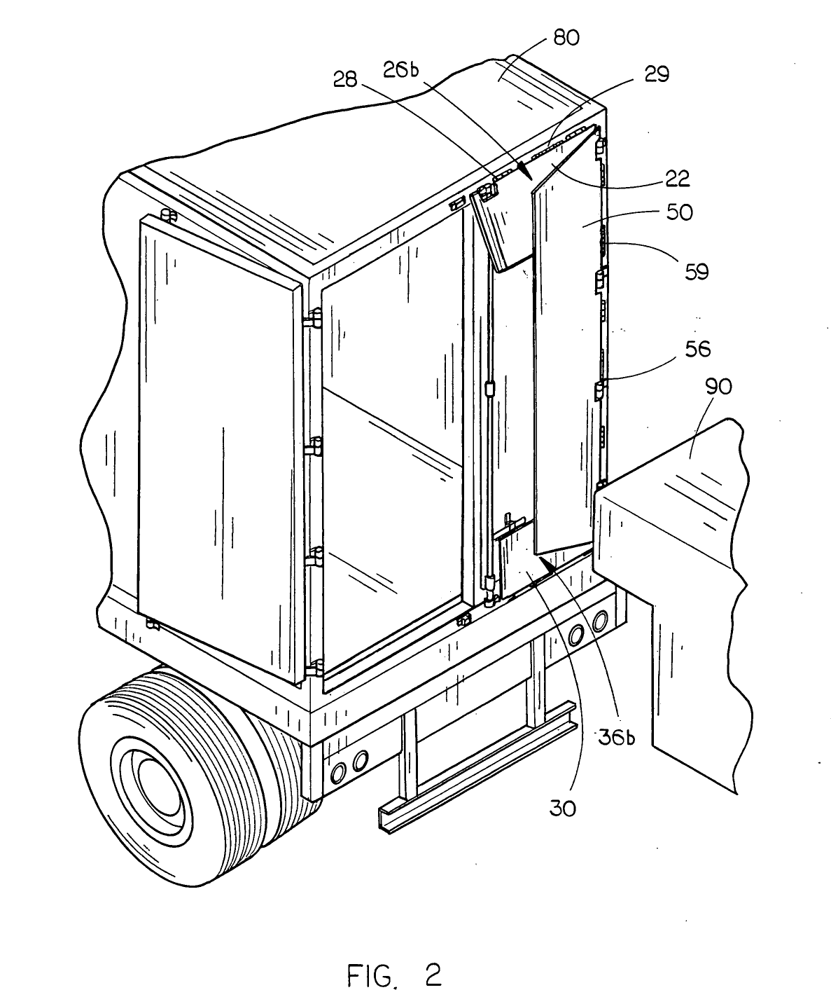

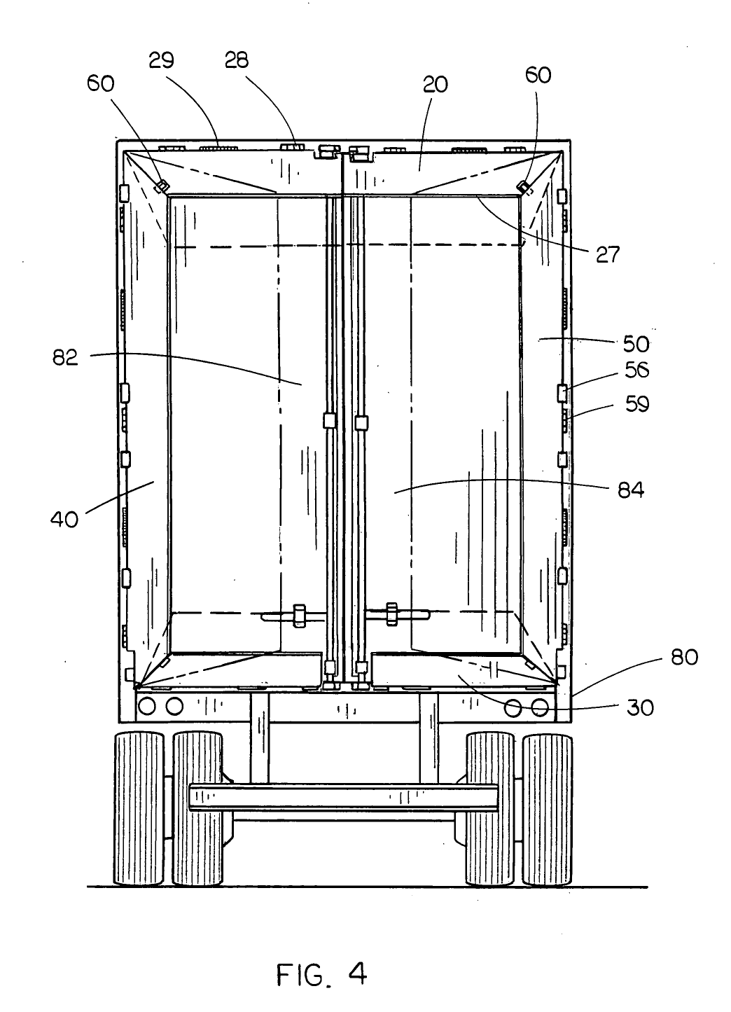

In the preferred embodiment, the left and right side panels 40 and 50 would be generally identical to one another, and likewise the top and bottom panels 20 and 30 would be generally identical to one another. Therefore, the following description of right side panel 50 and top panel 20 should be understood to relate generally to left side panel 40 and bottom panel 30 respectively. Right side panel 50 is preferably mounted on the outer edge of right rear door 84 of tractor-trailer 80, as shown best in FIGS. 1 and 2. Specifically, right side panel 50 would be mounted on the right rear door 84 itself by a plurality of hinges 56 which connect the inner edge 52 of right side panel 50 to the right rear door 84. The precise size, shape, and number of hinges 56 used in connection with the mounting of right side panel 50 is not particularly critical to the present invention so long as the hinges 56 generally permit the right side panel 50 to pivot between an extended position, as shown in FIG. 1 wherein the aerodynamic improvement capabilities of the right side panel 50 are utilized and a collapsed position generally adjacent the right rear door 84 as shown in FIG. 4.

In the preferred embodiment, the right side panel 50 would extend at an angle of approximately ten to fifteen degrees (10° to 15°) from parallel with the plane of the left side of the trailer 80, as it has been found that the range of five to twenty-five degrees (5° to 25°) provides the most significant increase in aerodynamic streamlining available via use of the air drag reduction apparatus 10 of the present invention. To secure the right side panel 50 in this extended position at the precise angle desired, a plurality of securement cables 58 would be connected to the right rear door 84 and extend outward to the right side panel 50 generally adjacent outer edge 54, as shown best in FIGS. 1 and 4. Of course, the securement cables 58 may be substituted by any appropriate securement device, such as hinge stops (not shown) which would be used in connection with the hinges 56 to prevent over rotation of the right side panel 50 beyond the desired position of the extended position.

Of course, the securement cables 58 only serve the purpose of preventing overrotation of the right side panel 50 beyond the desired extended position. It is therefore necessary to include an additional biasing device operatively associated with the right side panel 50 to bias the right side panel 50 outwards and rearwards until the securement cables 58 prevent further extension of the right side panel 50. There are several biasing mechanisms which may be used in connection with the present invention, such as tensioning springs, torsion bars or gas-filled cylinders, although in the preferred embodiment, the biasing devices will be either a tensioning spring 59 mounted in or adjacent each of the hinges 56 for biasing the associated hinge 56 outwards thereby pivoting right side panel 50 into its extended position, as shown best in FIGS. 1 and 2. Alternatively, a plurality of gas-filled cylinders may extend between and connect the right side panel 50 and right rear door 84 to provide a biasing effect to the right side panel 50 such that the right side panel 50 is biased into its extended position. Of course, the precise and specific nature of the biasing device is not critical to the present invention so long as the biasing devices bias the right side panel 50 outwards into the extended position and further are operative to permit controlled collapsing of the right side panel 50 to its collapsed position in response to certain external stimuli which will be described herein.

Regarding top panel 20, it is necessary to divide top panel 20 into left and right top subpanels 26a and 26b which, in the preferred embodiment, are generally identical mirror images of one another which are mounted to the top of the left and right rear doors 82 and 84, as shown best in FIGS. 1 and 2. As was described in connection with right side panel 50. Top panel 20 would be mounted on the left and right rear doors 82 and 84 by a plurality of hinges 28 which function in the same manner as the hinges 56 described in connection with right side panel 50. Furthermore, tensioning springs 29 would be mounted with hinges 28 to bias the top panel 20 rearwards and outwards, and securement cables 27 would function in the same manner as securement cables 58 described in connection with right side panel 50. Also, although, as shown in FIGS. 1-4, it is preferred that top panel 20 extend generally across the entire width of the trailer 80, the width of top panel 20 is preferably approximately 34 inches, whereas the width of the right side panel 50 is approximately thirty-six inches, although the precise size and shape of the panels may be modified or changed to adjust the performance characteristics of the air drag reduction apparatus 10 of the present invention. The primary purpose, however, for the smaller width of the top and bottom panels 20 and 30 relative to the left and right side panels 40 and 50 is so that the left and right side panels 40 and 50 overlap the top and bottom panels 20 and 30 such that when the left and right side panels 40 and 50 are moved forwards and inwards to their collapsible position, sliding wheels 60 mounted on the top and bottom panels 20 and 30 are engaged by the left and right side panels 40 and 50 and the top and bottom panels 20 and 30 are collapsed along with the left and right side panels 40 and 50. This collapsing configuration is important for several reasons, but the most important of these will be described immediately hereafter.

Until now, the air drag reduction apparatus 10 of the present invention as described incorporates many features found in the prior art. However, the significant and critical difference between the present invention and those inventions described in the prior art will now be described. Specifically, the biasing devices, namely the tensioning springs 29 and 59 and the hinges 28 and 56 are designed to releasably secure the top panel 20 and right side panel 50 in their extended positions under normal operating circumstances. However, one of the problems frequently encountered in operation of a tractor-trailer is that the tractor-trailer must be backed into a loading dock or the like in order to load and unload the trailer 80. With the vast majority of air drag reduction devices found in the prior art, the devices must be manually retracted or shifted into their retracted position. With the present invention, however, when any of the top, bottom, left side or right side panels 20, 30, 40 and 50 encounter an external object 90 such as the loading dock or the like, the tensioning springs 29 and 59 permit the impacted panel, specifically the right side panel 50 as shown in FIG. 2, to pivot about the hinges 56 towards and to the collapsed position generally adjacent the right rear door 84 without significant damage being done to the right side panel 50. When the trailer 80 is moved forwards out of contact with the loading dock 90, the tensioning springs 59 and hinges 56 act to re-extend the right side panel 50 to its extended position generally immediately after the contact with the external object, namely the loading dock 90, ceases. This feature virtually ensures that regardless of whether the operator of the tractor-trailer remembers to retract or extend the air drag reduction apparatus, with the present invention, such remembering is rendered unnecessary, thus freeing the operator of at least one additional burden which will likely facilitate his or her improved operation of the tractor-trailer unit.

This damage reduction feature of the present invention becomes even more important when accidental non-ballistic impact with any external object is occurring, such as when the trailer is accidentally backed into a building or another vehicle such as a fork lift or the like accidentally contacts the top, bottom, left side or right side panels 20, 30, 40 and 50. In virtually any event, the afflicted panel will retract from the extended position to its collapsed position until the contact with the external object ceases, at which time the afflicted panel immediately returns to its extended position in preparation for continued functioning as an air drag reduction apparatus. No other device found in the prior art currently accomplishes this significant improvement, and therefore the damage reduction capabilities of the air drag reduction apparatus 10 of the present invention are deemed to be not only novel but vital to the functionality of the present invention.

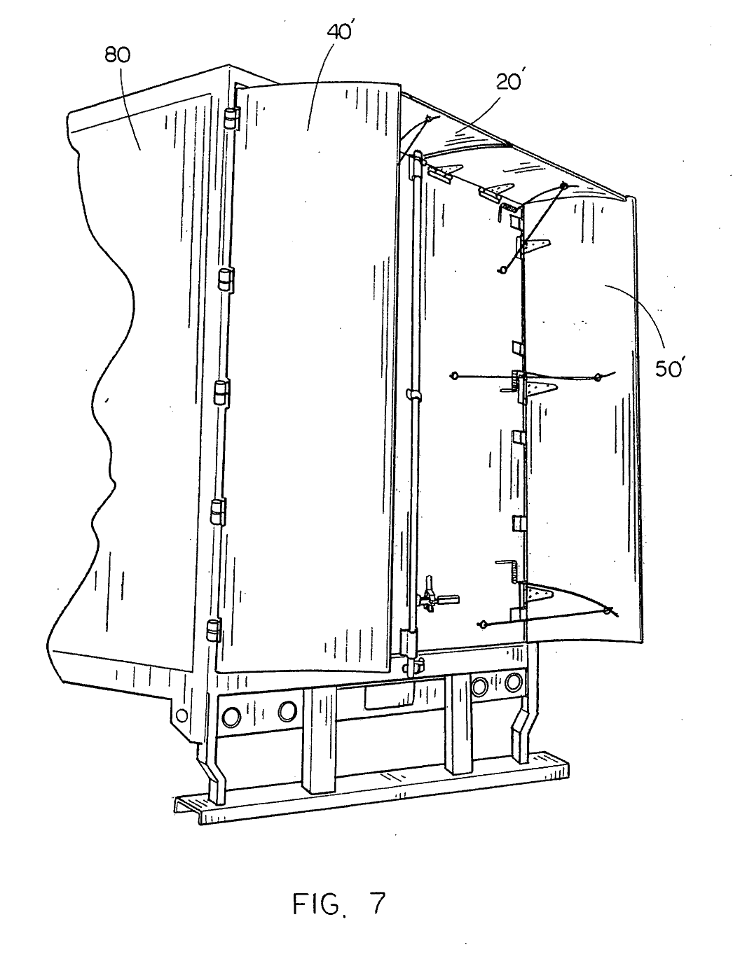

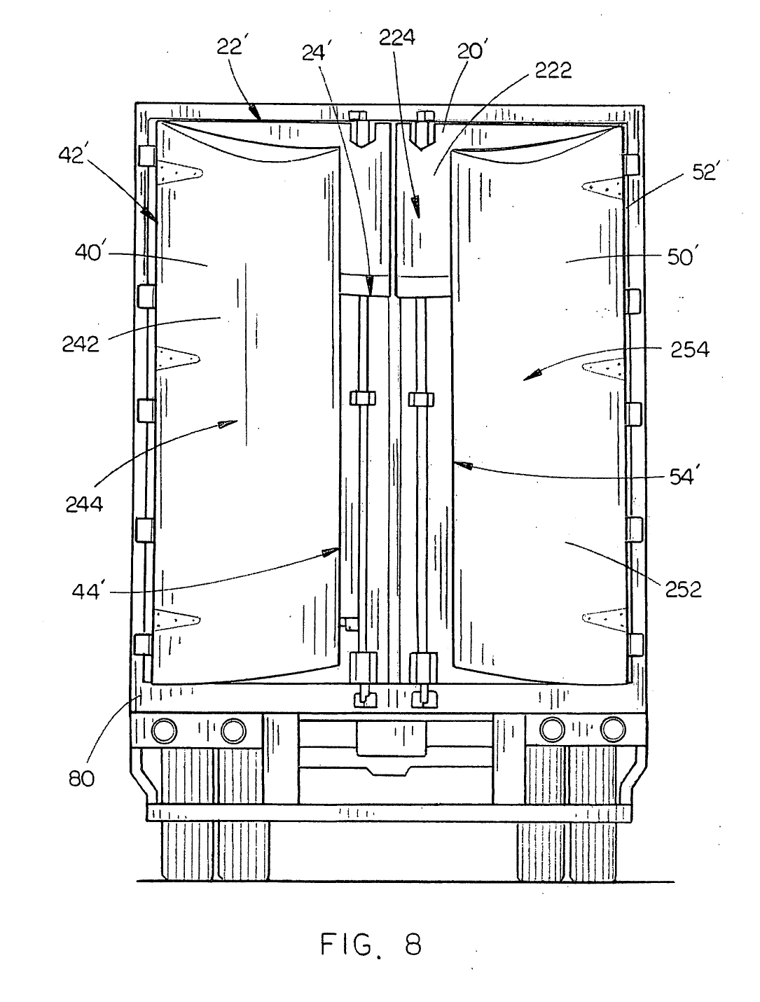

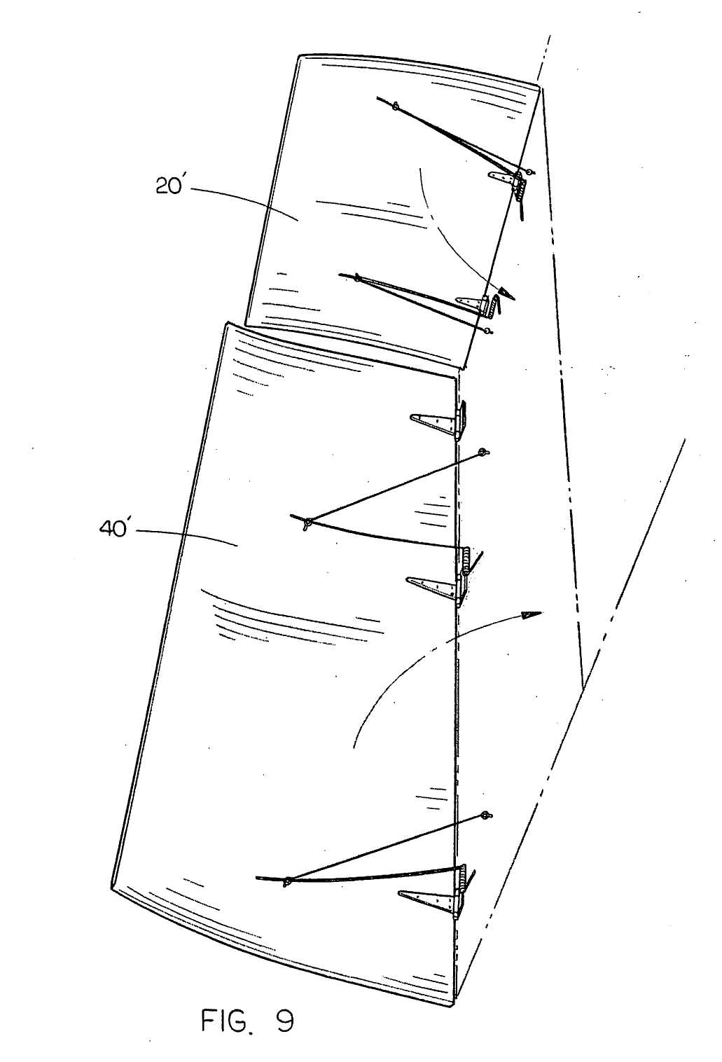

An alternative embodiment of the air drag reduction apparatus 10′ of the present invention is shown in FIGS. 7-11 as including top, left and right side panels 20′, 40′ and 50′ which include a significant improvement over the embodiment shown in FIGS. 1-4. Specifically, as seen best in FIGS. 7, 9 and 11, the top, left and right side panels 20′, 40′ and 50′ each include an arcuate convexly curved outer wall 222, 242 and 252 which changes the airflow over the top, left and right side panels 20′, 40′ and 50′ from the straight line flow of the first embodiment to an airflow more similar to that encountered with aircraft wings and airfoils. The important result of this significant modification is that the air passing over and flowing off of the top, left and right side panels 20′, 40′ and 50′ forms a less turbulent wake at the outer edges 24′, 44′ and 54′ of the top, left and right side panels 20′, 40′ and 50′ than that encountered during use of the embodiments of FIGS. 1-4, and in fact this results in significant improvement in the fuel consumption savings afforded by the use of the present invention.

In the preferred embodiment, the top, left and right side panels 20′, 40′ and 50′ each would include the arcuate outer walls 222, 242 and 252 as described above and as shown in FIGS. 7-11, and the curvature of the arcuate portions 224, 244 and 254 of the arcuate outer walls 222, 242 and 252 may be modified for use with particular models of trailers 80. It is preferred, however, that the convex curvature of the arcuate portions 224, 244 and 254 of arcuate outer walls 222, 242 and 252 be approximately ten to forty degrees (10° to 40°) of arc, with a radius of approximately two to ten feet, depending on the size and shape of the top, left and right side panels 20′, 40′ and 50′. Of course, it should be noted that particular convex curvature dimensions of the top, left and right side panels 20′, 40′ and 50′ are not necessarily critical to the proper operation of the present invention, so long as the outer edges 24′, 44′ and 54′ of each of the panels are positioned downwards and/or inwards from the inner edges 22′, 42′ and 52′ of each of the panels, as shown in FIGS. 7, 9 and 11, to enable to turbulence-reducing feature of the top, left and right side panels 20′, 40′ and 50′.

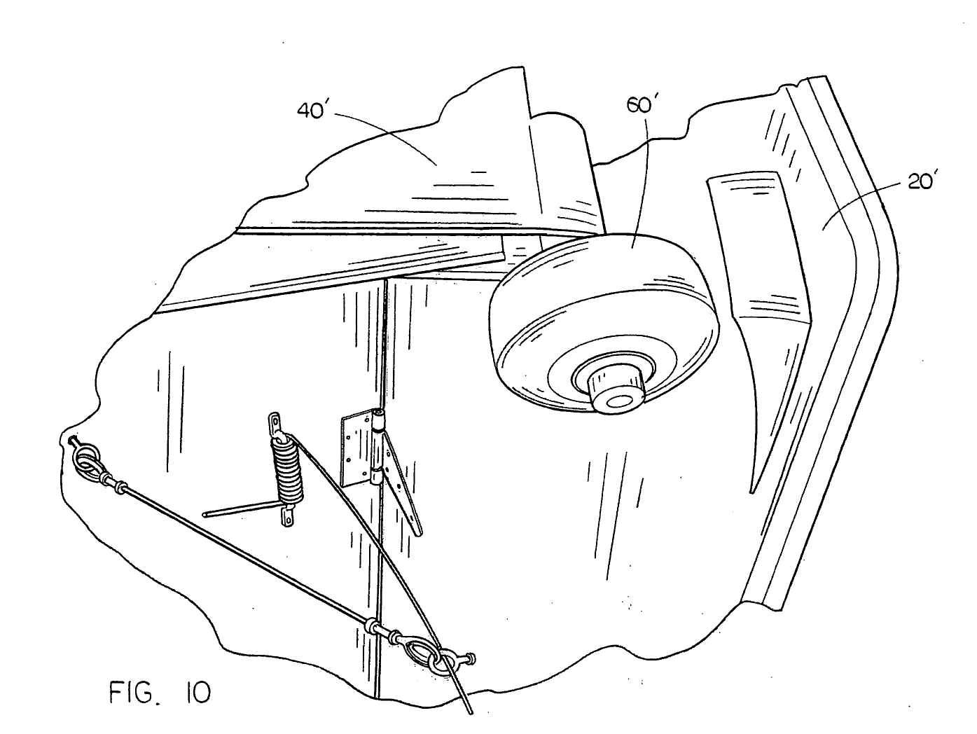

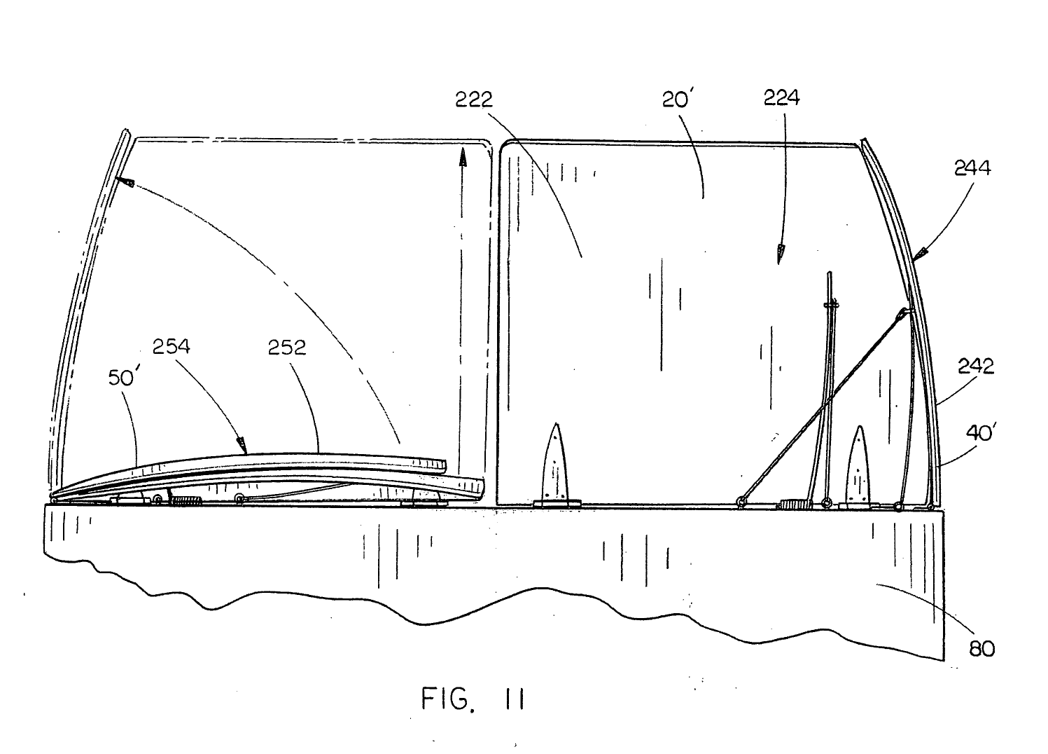

FIG. 10 illustrates an additional feature of the present invention, namely the improved sliding wheels 60′ mounted on the left and right side panels 40′ and 50′ which are engaged by the top panel 20′ so that the left and right side panels 40′ and 50′ are collapsed along with the top panel 20′ when the top panel 20′ is moved to the collapsed position as shown in FIG. 11. Finally, it should also be noted that manner by which the top, left and right side panels 20′, 40′ and 50′ are mounted on the trailer 80 and the hinges, tensioning springs and cables used in connection with the mounting and collapsing functionality of the top, left and right side panels 20′, 40′ and 50′ are generally identical to those described in connection with the embodiment of FIGS. 1-4, and therefore further discussion of those features in connection with the embodiment of FIGS. 7-11 is deemed unnecessary. However, due to the curvature of the top, left and right side panels 20′, 40′ and 50′, some modifications to the mounting of those panels on the trailer 80 may be found to be necessary, and such modifications would be understood by one skilled in the art of mounting after-market accessories on vehicles.

It is to be understood that numerous additions, modifications and substitutions may be made to the air drag reduction apparatus 10 of the present invention which fall within the intended broad scope of the appended claims. For example, the precise size, shape and construction materials used in connection with the top, bottom, left side and right side panels 20, 30, 40 and 50 and the top, left and right side panels 20′, 40′ and 50′ of FIGS. 7-11 may be modified or changed so long as the intended functionality of the panels is maintained. Also, although the biasing devices have been described as being either tensioning springs or gas cylinders, other types of biasing devices may be used in connection with the present invention so long as the function to releasably secure the panels in their extended positions absent contact with an external object which will force the afflicted panel towards and to the collapsed position generally adjacent the associated left or right rear door 82 and 84 is maintained. Furthermore, it should be noted that the top and bottom panels 20 and 30, specifically top subpanels 26a and 26b and bottom subpanels 36a and 36b, function generally independently of each other, as the division between the sub panels 26a, 26b, 36a and 36b must be maintained to permit the left and right rear doors 82 and 84 to properly open and close to provide access to the interior of the trailer 80. Also, regarding bottom subpanels 36a and 36b, it is preferred that they be spaced apart from one another in order to provide easy access to the locking handles of the left and right rear doors 82 and 84, as shown in FIGS. 1, 2 and 4, and this gap may be of any appropriate distance to perform this function. Finally, it should be noted that it is a critical feature of the present invention that the panels be mounted directly on the left and right rear doors 82 and 84 so that the panels will travel with the left and right rear doors 82 and 84 when the doors are being opened and closed. This will ensure proper functioning of the top, bottom, left side and right side panels 20, 30, 40 and 50 regardless of the precise size and configuration of the left and right rear doors 82 and 84.

There has therefore been shown and described an air drag reduction apparatus 10 which accomplishes at least all of its intended objectives.

I claim:

1. An air drag reduction apparatus for use with vehicles having generally rectilinear top, side and base walls and a generally rectangular rear door, said apparatus comprising:
left and right panels each having an inner edge and an outer edge, said left and right panels each including a convexly curved outer wall extending between said inner edge and said outer edge operative to smooth airflow over and off of said left and right panels;
a top panel having an inner edge and an outer edge, said top panel including a convexly curved outer wall extending between said inner edge and said outer edge operative to smooth airflow over and off of said top panel;
hinge means mounted on said inner edges of each of said left, right and top panels, said hinge means adapted to be mounted on the rear door of the vehicle such that said left, right and top panels are mounted on the rear door of the vehicle, said hinge means operative to permit each of said left, right and top panels to pivot between an extended drag-reducing position which extends generally rearwardly from the rear door and a collapsed position adjacent the rear door;
stop means operatively associated with each of said left, right, and top panels for releasably securing each of said left, right and top panels in said extended drag-reducing position; and
biasing means operatively associated with said left, right and top panels operative to bias said left, right and top panels outwards and rearwards to said extended position and further operative to permit said each of said left, right and top panels to pivot between said extended position towards and to said collapsed position upon said left, right and top panels receiving impact and contact from an external object and then return said left, right and top panels to said extended position substantially immediately upon contact with an external object ceasing whereby damage to said left, right and top panels from said impact is significantly reduced.

2. The air drag reduction apparatus of claim 1 wherein said left and right panels are generally trapezoidal in shape and have an airfoil cross-sectional shape.

3. The air drag reduction apparatus of claim 1 wherein said top panel is generally trapezoidal in shape and has an airfoil cross-sectional shape.

4. The air drag reduction apparatus of claim 1 further comprising a bottom panel having outer and inner edges, said bottom panel adapted to be mounted on the rear door of the vehicle adjacent the base thereof, hinge means mounted on said inner edge of said bottom panel, stop means operatively associated with said bottom panel for releasably securing it in said extended drag-reducing position and biasing means operatively associated with said bottom panel operative to bias said bottom panel outward and rearward to said extended position and further operative to permit said bottom panel to pivot between said extended position towards and to said collapsed position upon said bottom panel receiving impact and contact from an external object.

5. The air drag reduction apparatus of claim 4 wherein said stop means comprise a plurality of securement cables extending between and connecting selected ones of said left, right, top and bottom planar panels with a surface of the vehicle thereby preventing overrotation of said planar panels beyond said extended drag-reducing position.

6. The air drag reduction apparatus of claim 4 wherein said biasing means are selected from the group comprising tensioning springs, torsion bars and gas-filled cylinders.

7. The air drag reduction apparatus of claim 4 wherein said biasing means releasably secures said left, right, top and bottom planar panels in said extended position unless at least one of said left, right, top and bottom planar panels receives an impact from an external object, said biasing means then being operative to permit said each of said left, right, top and bottom planar panels to pivot between said extended position towards and to said collapsed position thereby lessening the impact force and substantially decreasing damage to said left, right, top and bottom planar panels.

8. The air drag reduction apparatus of claim 4 wherein said top and bottom planar panels are divided at approximately the midpoints thereof and thereby each include left and right subpanels, thereby permitting the rear door of the vehicle to be opened and closed.

9. The air drag reduction apparatus of claim 4 wherein said left and right planar panels overlap said top and bottom planar panels, said top and bottom planar panels each further comprising sliding wheels mounted on the outer ends of said top and bottom panels which are engaged by said left and right side panels such that said top and bottom panels are collapsed along with said left and right side panels being collapsed into said collapsed position.

10. In combination:
a tractor-trailer unit having generally rectilinear top, side and base walls and generally rectangular, outwardly swinging left and right rear doors;
an air drag reduction apparatus comprising;
left and right panels each having an inner edge and an outer edge, said left and right panels each including a convexly curved outer wall extending between said inner edge and said outer edge operative to smooth airflow over and off of said left and right panels;
a top panel having an inner edge and an outer edge, said top panel including a convexly curved outer wall extending between said inner edge and said outer edge operative to smooth airflow over and off of said top panel;
hinge means mounted on said inner edges of each of said left, right and top panels, said hinge means on said left and right panels mounted adjacent the outside edges of said left and right rear doors on said left and right rear doors, respectively, of said tractor-trailer, said hinge means of said top panel mounted adjacent said top edge of said left and right rear doors with said left and right subpanels of each of said top and bottom planar panels mounted on said left and right rear doors, respectively, said hinge means operative to permit each of said left, right and top panels to pivot between an extended drag-reducing position which extends generally rearwardly from the rear door and a collapsed position adjacent the rear door;
stop means operatively associated with each of said left, right and top panels for releasably securing each of said left, right and top panels in said extended drag-reducing position;
biasing means operatively associated with said left, right and top panels operative to bias said left, right and top panels outwards and rearwards to said extended position and further operative to permit said each of said left, right and top panels to pivot between said extended position towards and to said collapsed position upon at least one of said left, right and top panels receiving impact and contact from an external object and then return said left, right and top panels to said extended position substantially immediately upon contact with an external object ceasing whereby damage to said left, right and top panels from said impact is significantly reduced; and
said left, right and top panels operative to significantly reduce drag on said tractor-trailer when in said extended drag-reducing position thereby decreasing fuel consumption needed to transport said tractor-trailer.

11. The combination of claim 10 wherein said left and right panels are generally trapezoidal in shape and extend at an at an angle of between five to twenty-five degrees (5° to 25°) from parallel with the plane of the adjacent one of said side walls of said tractor-trailer and have an airfoil cross-sectional shape.

12. The combination of claim 10 wherein said top panel is generally trapezoidal in shape and extend at an at an angle of between five to twenty-five degrees (5° to 25°) from parallel with the plane of said top wall of said tractor-trailer and has an airfoil cross-sectional shape.

13. The air drag reduction apparatus of claim 10 further comprising a bottom panel having outer and inner edges, said bottom panel adapted to be mounted on said rear door of said tractor-trailer adjacent the base thereof, hinge means mounted on said inner edge of said bottom panel, stop means operatively associated with said bottom panel for releasably securing it in said extended drag-reducing position and biasing means operatively associated with said bottom panel operative to bias said bottom panel outward and rearward to said extended position and further operative to permit said bottom panel to pivot between said extended position towards and to said collapsed position upon said bottom panel receiving impact and contact from an external object.

14. The combination of claim 13 wherein said stop means comprise a plurality of securement cables extending between and connecting selected ones of said left, right, top and bottom panels with an adjacent one of said left and right rear doors of said tractor-trailer thereby preventing overrotation of said left, right, top and bottom panels beyond said extended drag-reducing position.

15. The combination of claim 10 wherein said biasing means are selected from the group comprising tensioning springs, torsion bars and gas-filled cylinders.

16. The combination of claim 13 wherein said biasing means releasably secures said left, right, top and bottom panels in said extended position unless at least one of said left, right, top and bottom panels receives an impact from an external object, said biasing means then being operative to permit said each of said left, right, top and bottom panels to pivot between said extended position towards and to said collapsed position generally adjacent one of said left and right rear doors thereby lessening the impact force and substantially decreasing damage to said left, right, top and bottom panels.

17. The combination of claim 13 wherein said top and bottom planar panels are divided at approximately the midpoints thereof and thereby each include left and right subpanels, thereby permitting said left and right rear doors of said tractor-trailer of the vehicle to be opened and closed.

18. The combination of claim 10 wherein said left and right panels overlap said top and bottom panels, said top and bottom panels each further comprising sliding wheels mounted on the outer ends of said top and bottom panels which are engaged by said left and right side panels such that said top and bottom panels and said left and right side panels all are collapsed into said collapsed position.
